(19) United States
(12) Patent Application Publication
(10) Pub. No.: US 2025/0379533 A1
(43) Pub. Date: Dec. 11, 2025

(54) METHOD FOR BRAKING A POWER TOOL, AND POWER TOOL

(71) Applicant: Hilti Aktiengesellschaft, Schaan (LI)

(72) Inventor: Markus SCHERBAUM, Gennach (DE)

(21) Appl. No.: 19/206,778

(22) Filed: May 13, 2025

(30) Foreign Application Priority Data
Jun. 6, 2024 (EP) 24180425.1

(51) Int. Cl. H02P 21/36; B24B 27/08; B25F 5/00

(52) U.S. Cl. CPC H02P 21/36; B24B 27/08; B25F 5/00

(57) ABSTRACT

A method for braking a power tool (10) is provided, the power tool (10) being a battery-operated or mains-operated power tool and including a brake chopper, and at least pert of the electrical energy that is released when the power tool (10) is braked being fed back to a power supply device (14) or a DC link of the power tool (10).

This claims priority to European Patent Application EP 24180425.1 filed on Jun. 6, 2024 which is hereby incorporated by reference herein.

The present invention relates to a method for braking a power tool. In a second aspect, the invention relates to a power tool for carrying out the braking method.

### BACKGROUND OF THE INVENTION

In the field of power tools, it is known practice to slow down the tools of the power tools in order to finish work or for safety reasons. The following braking methods in particular are known in the prior art: short-circuit braking, using a brake chopper as a braking resistor and recuperation.

### SUMMARY OF THE INVENTION

With short-circuit braking, the motor of the power tool is shorted. This can be achieved for example by switching on all the low-side semiconductors of the motor inverter at the same time. An initially higher initial short-circuit current can form, which then turns into a constant short-circuit current. The short-circuit current generates a braking torque in the motor of the power tool that can be used to slow down the power tool, or its tool. A disadvantage of short-circuit braking is that the user has little influence on the braking torque or the braking time. The level of the short-circuit current is determined only by motor parameters. Moreover, the electronics of the power tool must be able to carry the comparatively high initial short-circuit current at the start of short-circuit braking. If the power tool is not designed to withstand such short-circuit currents, damage to the power tool, or its electronics, can occur.

When a brake chopper is used as a braking resistor, the motor of the power tool can be braked in a controlled manner so that it becomes the generator. The energy delivered can be fed back to a DC link of the electronics of the power tool. The power tool can have a brake chopper as a braking resistor, the brake chopper being configured to connect a resistor to the DC link to thereby turn the energy in the braking resistor into heat. Although using a brake chopper affords more degrees of freedom for attaining certain desired braking torques or braking times, a disadvantage of using a brake chopper is that at least one additional hardware part must be installed in the power tool. This increases the weight of the power tool and its volume. For example, a larger volume can afflict the ergonomics or the handling of the power tool. Installing a brake chopper often also entails the need for other, additional electronic parts, such as MOSFETs, gate drivers or connecting wires, which can in particular also complicate the manufacture or the assembly of the power tool. Especially if the brake chopper is meant to be designed for high pulse powers, the costs for the power tool and also the installation space required inside the power tool can rise considerably.

Recuperation is possible only if power supply devices with feedback capability are used in the power tool. The motor of the power tool can be braked in a controlled manner during recuperation and thus become the generator. The energy delivered can be fed back to the DC link and transferred from there to the power supply devices. The quality and recuperation capacity of the power tool largely depend on the power supply device installed in the power tool. During braking operations for which, for example, the braking current is supposed to be constant or a braking ramp is specified, operating states can arise that load the power supply device such that limit values that, for example, affect electrical properties of the power supply device, such as voltage or current carrying capacity, can be exceeded. This can result in damage to the power supply device. In order to avoid exceeding these limit values, it has been known practice in the prior art to date to carry out the braking operation as slowly as possible. This is not a good idea, however, especially if the power tool needs to be slowed down quickly, for example in order to quickly and reliably protect the user of the power tool from injury.

It is an object of the present invention to overcome the defects and disadvantages of the prior art that are described above and to provide methods for slowing down a power tool, and also a power tool, so that, firstly, the most effective possible protection of a user of the power tool can be permitted and, secondly, a compact, manageable power tool can be provided. Moreover, the released energy should be fed back to the power supply device as effectively as possible in order to provide a power tool that is as resource-saving as possible and has a good battery range.

The invention provides for a method for braking a power tool, the power tool being a battery-operated or mains-operated power tool and comprising a brake chopper, and at least part of the electrical energy that is released when the power tool is braked being fed back to a power supply device or a DC link of the power tool. The braking method is characterized by the following method steps:
a) regeneratively braking a motor-driven drive of the power tool,
b) feeding back the electrical energy that is released when the power tool is braked to the power supply device or the DC link of the power tool,
c) determining whether the electrical energy that is released when the power tool (10) is braked exceeds at least one limit value of the power supply device or of the voltage of the DC link,
d) absorbing a share of the electrical energy by way of the brake chopper if the electrical energy released during braking exceeds the at least one limit value of the power supply device or of the voltage of the DC link.

The method can be used firstly to permit the shortest possible braking time and secondly to provide a compact, manageable power tool. The particularly short braking time allows the user of the power tool to be protected against injury particularly effectively. The method advantageously permits recuperation, i.e. feedback of electrical energy to a power supply device in a power tool, with particularly high efficiency. There is provision for a brake chopper, which can be used in a particularly simple way to turn an excess of electrical energy generated when the power tool is braked into heat. In particular, the brake chopper is activated only if the electrical energy generated by braking exceeds a limit value of the power supply device or of the voltage of the DC link. The limit value is determined or predetermined in such a way that it corresponds to an electrical power from which the power supply device or the DC link could be damaged or the health of the user could be put at risk. The inventive method is used in particular to easily determine the part of the electrical energy that needs to be absorbed by the brake chopper. The intention is to dispense with a separate controller for the brake chopper.

The method advantageously allows the released braking energy to be fed back to the power supply device particularly efficiently and only the excess of electrical energy to be removed via the brake chopper. It is preferred in accordance with the invention that the power tool can be connected to at least one power supply device, or a DC link, in order to be supplied with electrical energy. By way of example, the power tool can have receiving areas, or options for coupling one, two or more power supply devices, such as batteries or rechargeable batteries. It is preferred in accordance with the invention that the terms “rechargeable battery”, “battery” and “power supply device” are used synonymously. The electronics of the power tool and its motor are preferably operated at an optimum operating point with particularly low power loss. To achieve this, the power tool can be operated for example along a characteristic curve with optimized power losses. In accordance with the invention, the statement that the power tool is operated along a characteristic curve with optimized power losses preferably means that the losses during operation of the power tool can be minimized with the invention. These may be iron and/or copper losses, for example. The statement that the power tool is operated along a characteristic curve with optimized power losses can moreover mean that the power tool is operated in a manner optimized in terms of current yield and/or efficiency.

According to one embodiment of the present invention, a correction factor k_red is determined on the basis of a difference between the electrical energy released during braking and the limit value of the power supply device or of the voltage of the DC link, wherein a duty factor of the brake chopper is determined on the basis of the correction factor k_red. In other words, the power draw of the brake chopper, i.e. the electrical energy dissipated by the brake chopper, is proportional, in particular directly proportional, to a manipulated variable formed from controller output variables. These controllers are used to comply with the limit values. The brake chopper is used to absorb the excess of electrical energy released that cannot be absorbed by the power supply device or the DC link. For example, the correction factor can range from 0 to 1 (0% to 100%). The correction factor k_red may be inversely proportional to the difference between the electrical energy released during braking and the limit value of the power supply device. This difference can also be referred to as excess energy that can no longer be returned to the power supply device or cannot be returned without risk. The correction factor k_red may be 1 while there is no excess energy, or the limit value is not exceeded. The applicable controller may be limited to a manipulated variable (k_red) of 1. When the limit value is exceeded, the result is the aforementioned difference, or the excess energy, which can be removed firstly by the chopper and, if necessary, secondly by reducing the motor current.

According to another embodiment, the correction factor kred is made up of a first correction parameter kU_red and a second correction parameter kl_red, in particular of a product of the first correction parameter kU_red and the second correction parameter kl_red, wherein the first correction parameter kU_red is preferably determined by a voltage controller of the power supply device, and wherein the second correction parameter kl_red is preferably determined by a current controller of the power supply device. The voltage controller may be designed, for example, to determine when a maximum voltage value for the power supply device, or the DC link, is exceeded. When the maximum voltage value is exceeded, the voltage controller can output a first correction parameter kU_red that is inversely proportional to the difference between the motor voltage generated during braking and the maximum voltage value. In other words, the greater the excess voltage, the lower the first correction parameter kU_red. The current controller may be designed, for example, to determine when a maximum current level for the power supply device, or the DC link, is exceeded. When the maximum current level is exceeded, the current controller can output a second correction parameter kl_red that is inversely proportional to the difference between the motor current generated during braking and the maximum current level. In other words, the higher the flow of current, the lower the second correction factor kl_red.

According to another embodiment, the duty factor D of the brake chopper is determined on the basis of a ratio of the correction factor k_red to a mapping limit k_Mapping, the mapping limit k_Mapping corresponding to a limit value of the correction factor k_red from which the braking power of the power tool is reduced. According to this embodiment, the proposal is to introduce a mapping limit from which removal of excess energy generated when the motor is braked is achieved no longer exclusively via the brake chopper, but additionally by reducing the motor current. The mapping limit corresponds in particular to a pre-definable or dynamically determinable value of the correction factor k_red. In other words, the mapping limit defines the correction factor (i.e. reduction factor) up to which only the brake chopper is used to remove the excess energy. According to this variant embodiment, it is not necessary to provide a separate controller for the brake chopper. Rather, the duty factor D of the brake chopper can also be controlled via the voltage controller and the current controller. This is possible in particular because the voltage controller and the current controller determine the correction factor k_red.

According to another embodiment, the duty factor D of the brake chopper has the value 1 if the correction factor k_red is less than or equal to the mapping limit k_Mapping. In other words, the brake chopper is under full load, i.e. the brake chopper is operating at the maximum possible duty factor, while the correction factor is below the mapping limit. On the other hand, the brake chopper is switched off only if the correction factor is 1, that is to say no excess energy is generated during braking. When the correction factor decreases between 1 and the mapping limit, the duty factor increases indirectly proportionally, i.e. the duty factor rises proportionally until the maximum duty factor of the brake chopper is reached, in particular when the correction factor reaches the mapping limit.

According to another embodiment, the duty factor D of the brake chopper is determined using the following formula while the correction factor is above the mapping limit:

$$D = kred / ( kMapping - 1 ) - 1 / ( kMapping - 1 )$$

According to this function, the duty factor D is increased continuously, while the correction factor decreases between 1 and the mapping limit.

The mapping limit can have a value between 0 and 1. In particular, the mapping limit can assume any value of the correction factor.

The mapping limit can be a constant and/or predetermined value. For example, the mapping limit may be set to a correction factor of 0.6. In this case, a reduction in the energy generated by braking, as determined by the correction factor, is achieved by the brake chopper until more than 40% (1-0.6) of the energy generated during braking is surplus. While the correction factor is greater than the mapping limit (here e.g. k_red>0.6), the complete excess energy can be converted in the brake chopper.

In another embodiment, the mapping limit is determined dynamically, in particular on the basis of a mechanical braking power of the power tool and a chopper braking power. As will be explained in more detail later, depending on the (dynamically) determined value for the mapping limit, a slope of the recuperation performance is different depending on the correction factor before and after the mapping limit. It is advantageous if the mapping limit is selected so that the slopes are approximately the same, i.e. there is no bend in the recuperation performance curve. A bend having different slopes would result in different loop gains of the control loop, which could therefore become unstable in one range. Put simply, the method can have a step in which the mapping limit is selected so that it corresponds to a ratio of the mechanical braking power of the power tool to the total braking power (mechanical braking power of the power tool+chopper braking power). Thus, if the mechanical braking power of the power tool corresponds to 60 percent of the total braking power, the mapping limit is preferably defined as 0.6.

The power tool can be operated along an MTPA characteristic curve in a space vector representation, the abbreviation MTPA standing for “maximum torque per ampere”. This advantageously allows the power tool to be operated with an optimum current yield. It has been found that the power tool can be operated with particularly low losses, or low power losses, in this way. By preference, a maximum setpoint motor stator current I_S, max, which is preferably also referred to as maximum motor current I_S, max, is specified in the context of the invention. This maximum motor current I_S, max can thus be a first current value in accordance with the invention. If the feedback, or feedback power, is too high, however, limit values, which are supposed to ensure reliable operation of the power supply device, can be exceeded. These limit values can relate to the voltage and/or current of the power supply device. They are referred to as limit values of the power supply device, or as “battery limit values”, in accordance with the invention. It is preferred in accordance with the invention that the battery limit value for the voltage is referred to as U_Akku, max and the battery limit value for the current is referred to as I_Akku, max.

Alternatively or additionally, the first current value may be the setpoint motor current I_S, soll. It is preferred in accordance with the invention that the battery limit values are initially prevented from being exceeded by way of active control of the brake chopper. This is accomplished by activating the brake chopper, preferably after at least one of the battery limit values has been recognized as having been exceeded.

In one configuration of the invention, the power tool can be operated for example with a setpoint motor current I_S, soll. Moreover, a maximum motor current I_S, max can be specified, the braking power of the power tool being reduced if a limit value of the power supply device, or of the DC link, is exceeded even after full operation of the brake chopper. The braking power of the power tool can then be reduced as a result of a current space vector I_S, max being rotated in the space vector representation, by applying a modified braking angle β_brems, such that a length of the current space vector I_S, max remains essentially unchanged. Rotation of the current space vector I_S, max allows the modified setpoint current values, preferably for the d- and q-axes of the space vector representation, to be determined and the braking power of the power tool to be decreased in this way. It is preferred in this configuration of the invention that the maximum stator current I_S, max and the braking angle β_brems are used to determine the setpoint current values, preferably for the d- and q-axes of the space vector representation, the setpoint current values, preferably for the d- and q-axes, as an output variable or a manipulated variable, being intended to be taken as a basis for the remainder of the slowing process.

It is preferred that a correction factor k_Dreh can be determined even if the current space vector I_S, max is rotated. By preference, the correction factor k_Dreh can be applied to an angular position of the current space vector I_S,max, and so a rotation of the current space vector I_S,max with a modified braking angle β_brems is obtained.

In another configuration of the invention, the braking power of the power tool can be reduced as a result of at least one current correction factor being determined and applied to the maximum motor current I_S, max. This allows a reduced setpoint value I_S, red for the motor current to be obtained, on the basis of which the modified setpoint current values, preferably for the d- and q-axes of the space vector representation, are then determined again and the braking power of the power tool is thus decreased. The reduced setpoint value I_S, red for the motor current can be relayed to a motor current controller, and so the motor current can be controlled, or set, on the basis of the reduced setpoint value I_S, red. It is preferred in accordance with the invention that in this configuration the braking power of the power tool is reduced as a result of the current space vector being shortened. In other words, the application of the current correction factor k to the maximum motor current I_S, max is used to shorten the current space vector, as a result of which the braking power of the power tool can advantageously be reduced thereby. The current correction factor can be determined on the basis of a ratio of the correction factor to the mapping limit. In particular, the current correction factor can be determined using the following formula while the correction factor is below the mapping limit (above the mapping limit, only the brake chopper is active and the motor current is not reduced):

$${k}_{S , red} = {k}_{red} / {k}_{Mapping}$$

In another configuration of the invention, the power tool can be operated by specifying the maximum motor current I_S, max. The braking power of the power tool can be decreased either as a result of at least one current correction factor k being determined and applied to the maximum motor current I_S, max, so that a reduced setpoint value I_S, red for the motor current is obtained, or as a result of the current space vector I_S, max being rotated in the space vector representation, so that a length of the current space vector I_S, max remains essentially unchanged. The current space vector I_S, max can preferably be rotated as a result of a modified braking angle β_brems being applied to the current space vector I_S, max.

Rotation of the current space vector I_S, max allows an operating point of the motor of the power tool to be set to a lower torque and therefore also a lower braking power without lessening the stator current amplitude. This high stator current can then furthermore cause high losses within an inverter, the electronics and/or the motor, and so the braking energy can be absorbed and turned into heat. By preference, even when power draw is limited, a surprisingly large power loss can be converted in the electronics, the inverter and/or the motor of the power tool when electrical energy is fed back to the power supply device. This advantageously allows an additional drop in power to be obtained and the braking operation to be made even faster. In particular, application of the modified braking angle β_brems and the resultant rotation of the current space vector I_S, max in the space vector representation allows regenerative braking operation with high losses to be provided for a power tool in order to slow down its tool, the method initially not requiring a brake chopper. By preference, the braking angle β_brems can preferably also be referred to as “stator current space vector angle β_brems” in accordance with the invention.

It is preferred in accordance with the invention that when the current space vector I_S, max is rotated to reduce the braking power, the battery voltage controller and the battery current controller are used to determine, or output, correction factors as a manipulated variable. Such reduction of the braking power is preferred in particular when the power supply device and an optional braking resistor, such as a brake chopper, have reached their maximum power draw. This can advantageously have the effect that battery limit values are maintained and the power supply device is not damaged. In particular, rotation of the current space vector allows an operating point in the space vector representation with a decreased braking torque to be obtained. The decreased braking torque can be obtained in particular by way of a shortened current space vector and/or by way of a rotated current space vector.

The ability to absorb electrical energy may be limited for a brake chopper if an ON duty ratio of 100% or substantially 100% is attained. In order to circumvent such a restriction by the ON duty ratio, it may be preferred in accordance with the invention to use a comparatively low-resistance brake chopper. By preference, the brake chopper can have an electrical resistance in a range from 0.1 to 2 ohms. Such brake choppers or braking resistors are preferably referred to as “low-resistance brake choppers” in accordance with the invention.

As the power tool comprises a brake chopper, an energy distribution for the braking method can be described as follows: First, the released braking energy is fed back to the power supply device. If the power supply device can no longer absorb the braking energy, or braking power, the remaining excess energy can be routed to the brake chopper. If the brake chopper can no longer absorb the braking energy, or the braking power, the braking power of the motor can be reduced by way of a lower braking torque.

By preference, the braking angle β_brems can preferably also be referred to as “stator current space vector angle β_brems” in accordance with the invention. In the context of the present invention, this braking angle β_brems can be calculated as follows:

$${β}_{brems} = {k}_{red} \cdot ( {β}_{brems , MTPA} - {β}_{brems , 0 Nm} ) + {β}_{brems , 0 Nm} .$$

The parameter βbrems, MTPA preferably corresponds to the angle on the MTPA characteristic curve, while the parameter βbrems, 0 Nm corresponds to the current space vector angle used to attain an operating point with a torque formation of 0 Nm or substantially 0 Nm. For example, this operating point may be located in the third quadrant or in the fourth quadrant of the space vector representation. The third quadrant should explicitly also include the border with the second quadrant (the limit at the top of the third quadrant) and the fourth quadrant should explicitly also include the border with the first quadrant (the limit at the top of the fourth quadrant). As can be seen in FIG. 2a, the border of the third quadrant with the second quadrant is the location of the intersection of the current limit circle K with the 0 Nm characteristic curve of the space vector representation, and preferably no torque is generated. As can be seen in FIG. 2b, the intersection of the current limit circle K with the 0 Nm characteristic curve can also be located in the fourth quadrant. The maximum stator current I_S, max and the current space vector angle βbrems can advantageously be used to calculate the setpoint current values, preferably for the d-axis and the q-axis of the space vector representation.

The operating range AB of the so-called current space vector I_S is shown in the corresponding space vector representation (cf. FIG. 1). Without limiting the feedback of energy, i.e. the “battery recuperation”, the longest current space vector I_S is obtained on the MTPA characteristic curve. The current space vector I_S is in particular a stator current space vector, i.e. in particular the space vector for the stator current of the electric motor of the power tool is represented. It is preferred in accordance with the invention that the current space vector I_S is limited by a current limit of the inverter of the electronics of the power tool. This current limit of the inverter is also shown in the space vector representation depicted in FIG. 1, specifically as circle K. By preference, when the battery limit value for the voltage (U_Akku, max) is reached and/or when the battery limit value for the current (I_Akku, max) is reached, the current space vector I_S can be shortened to the extent that the battery limit values are not exceeded. The current space vector I_S is preferably shortened by applying the at least one correction factor k.

It is preferred in accordance with the invention that the tool of the power tool is stopped with a braking time in a range from 2 to 4 seconds. Slowing down the tool of the power tool with a braking time between 2 and 4 seconds(s) can protect in particular the parts and components in the drive train of the power tool. It is preferred in accordance with the invention that the braking torque of the power tool can be adjusted such that braking times between 2 and 4 s can be attained.

If a kickback event is detected by the power tool, it may be preferred in accordance with the invention that the tool of the power tool is stopped with a braking time of less than 1.5 seconds, preferably less than 1 second, most preferably less than 0.5 second. This allows the tool of the power tool to be slowed down as quickly as possible to optimally protect the user of the power tool from injury. In accordance with the invention, the statement that the power tool or its tool is stopped means that the tool of the power tool is brought to a standstill. However, in accordance with the invention, the statement that the power tool or its tool is stopped can also mean that the tool is divested of a large share of its rotational energy and that the tool of the power tool now continues to rotate only in a speed range that is less dangerous for the user. In accordance with the invention, the expression “large share of its rotational energy” can preferably mean that more than 50% of the rotational energy of the tool is turned into another form of energy and/or fed back to the power supply device. It is quite particularly preferred in accordance with the invention that in the context of the braking method more than 60%, 70%, 80%, 90% or 95% of the rotational energy of the tool is turned into another form of energy and/or fed back to the power supply device. By preference, the tool of the power tool can be slowed down with a braking time of less than 1.5 seconds, preferably less than 1 second, most preferably less than 0.5 second, such that the tool of the power tool loses a large share of its rotational energy. In accordance with the invention, this preferably means that the tool of the power tool is deprived of more than 50%, preferably more than 60%, 70%, 80%, 90% or 95%, of a rotational energy and that more than 50%, preferably more than 60%, 70%, 80%, 90% or 95%, of the rotational energy is turned into another form of energy and/or fed back to the power supply device. Of course, all intermediate values between 50 and 100%, which are meant by the expression “large share of the rotational energy”, are also possible, that is to say for example more than 53%, more than 66.66%, more than 75%, more than 87.5% or more than 93.76%.

The power tool, or its tool, is slowed down by way of the braking method, in which the braking power of the power tool is reduced when at least one limit value of the power supply device is exceeded and this additionally released braking energy can no longer be absorbed by the brake chopper.

In a second aspect, the invention relates to a power tool for carrying out the method. The terms, definitions and technical advantages introduced for the braking method preferably apply mutatis mutandis to the power tool. The motor of the power tool is a brushless motor that can preferably deliver a power of more than 1.8 kilowatts (KW). By preference, the power tool can be a brushless-control electrical unit with a braking function. By way of example, the power tool may be in the form of an electrically operated cut-off grinder. It is quite particularly preferred in accordance with the invention that the power tool is a battery-operated cut-off grinder with a cutting disk as a tool. The power tool can be connected to at least one power supply device in order to be supplied with electrical energy by the power supply device. The at least one power supply device of the power tool can, for example, deliver a voltage of more than 20 volts (V). A voltage between 21 and 22 V is particularly preferred. The power tool can also have two or more power supply devices. If the power tool has more than one power supply device, the electrical energy released when the power tool is braked can be fed back to the first and/or the second power supply device. This recuperation can essentially take place simultaneously, sequentially or according to a specially designed algorithm.

The cutting disk is a disk-shaped tool of the cut-off grinder that can be slowed down and brought to a standstill using the braking method. The cutting disk can have a diameter greater than, for example, 230 millimetres (mm). By way of example, the cutting disk can have a diameter of 300 mm, 250 mm or 400 mm, without being limited thereto. For example, a weight of the cutting disk can be in a range between 200 and 2500 grams, i.e. between 0.2 and 2.5 kilograms (kg). By way of example, the weight of the cutting disk can assume values of 210 grams, 530 grams, 550 grams, 930 grams, 1270 grams, 1280 grams, 1720 grams or 2450 grams, without being limited thereto. By way of example, the cutting disk can be a diamond cutting disk or an abrasive cutting disk with bonded abrasive grains. A diamond cutting disk is preferably characterized in that it has a steel core with diamond segments.

It is preferred in accordance with the invention that the motor of the power tool can be controlled using field-oriented control or block commutation. In a preferred configuration of the invention, it is preferred that the braking angle β_brems can be modified in order to reduce the braking power of the power tool and to rotate the current space vector I_S, max in the space vector representation. If the motor of the power tool is controlled using block commutation, it may also be preferred in accordance with the invention that the commutation angles are modified in order to reduce the braking power of the power tool. In a preferred configuration, the commutation angles are modified in such a way that the resultant commutation blocks are trailing. The power tool can comprise a brake chopper, the brake chopper being configured to absorb electrical energy that is released when the tool of the power tool is braked. The brake chopper is in particular configured to absorb additional electrical energy, in addition to the power supply device, that the power supply device can no longer absorb due to a limited power draw.

### BRIEF DESCRIPTION OF THE DRAWINGS

Further advantages will become apparent from the description of the figures that follows. The figures, the description and the claims contain numerous features in combination. A person skilled in the art will expediently also consider the features individually and combine them to form useful further combinations.

In the figures, identical and similar components are denoted by the same reference signs.

In the figures:

FIG. 1 shows an operating range of a possible stator current space vector in a space vector representation during efficient regenerative braking operation;

FIGS. 2a and 2b show an operating range of a possible stator current space vector in a space vector representation during supremely lossy regenerative braking operation;

FIG. 3 shows a possible “recuperation” block diagram with efficient regenerative braking operation without a brake chopper;

FIG. 4 shows a possible “recuperation” block diagram with efficient regenerative braking operation with a brake chopper;

FIG. 5 shows a possible “recuperation” block diagram with supremely lossy regenerative braking operation without a brake chopper;

FIG. 6 shows a possible “recuperation” block diagram with supremely lossy regenerative braking operation with a brake chopper;

FIG. 7 shows a schematic plot of speed against time to illustrate braking time and acceleration time;

FIG. 8 shows a schematic plot of speed against time to illustrate braking time and acceleration time;

FIG. 9 shows a schematic representation of a configuration of the power tool;

FIG. 10 shows an inventive “recuperation” block diagram with efficient regenerative braking operation with a brake chopper and reduction of the motor current as a result of rotation of the current vector;

FIG. 11 shows an inventive “recuperation” block diagram with efficient regenerative braking operation with a brake chopper and reduction of the motor current as a result of shortening of the current vector; and

FIG. 12 shows a schematic representation of a mapping algorithm.

### DETAILED DESCRIPTION

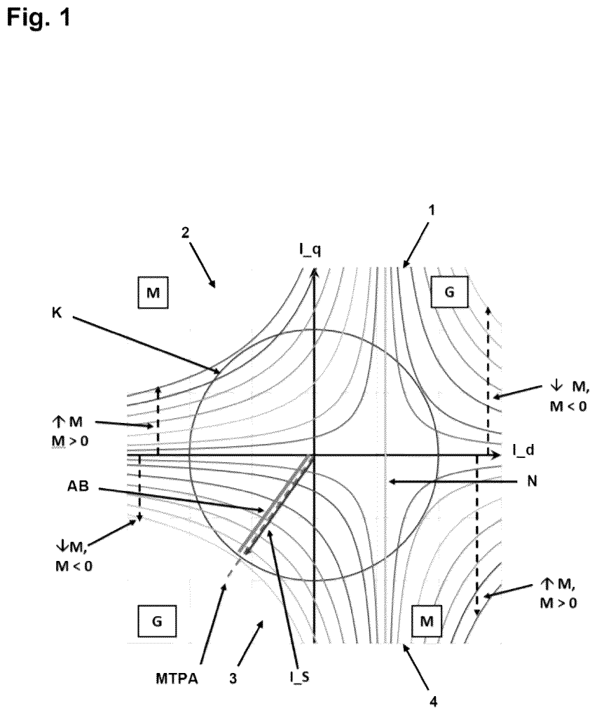

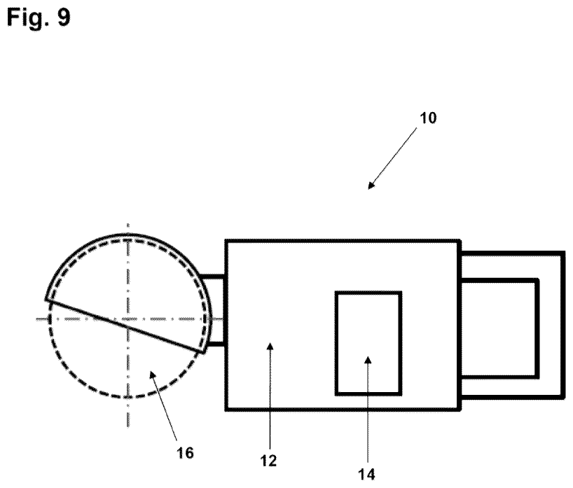

FIG. 1 shows a possible space vector representation that depicts the operation of a power tool 10. In particular, FIG. 1 shows the operating range AB of a possible stator current space vector I_S in such a space vector representation during efficient regenerative braking operation of the power tool 10. The x-axis of the space vector representation shows the I_d value of the current that flows through the motor 12 of the power tool 10. A power tool 10 is shown schematically in FIG. 9.

The y-axis of the space vector representation shows the I_q value of the current that flows through the motor 12 of the power tool 10. The value I_q signifies the torque-forming component of the current, while the value I_d signifies the field-forming current component.

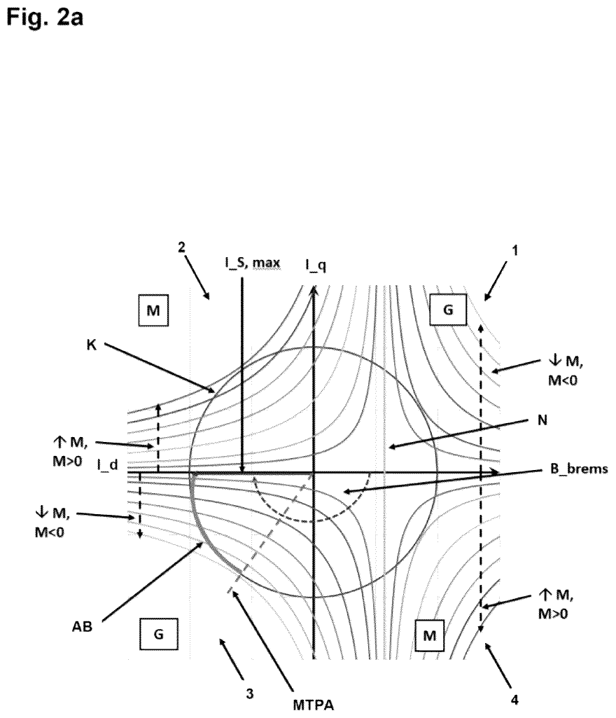

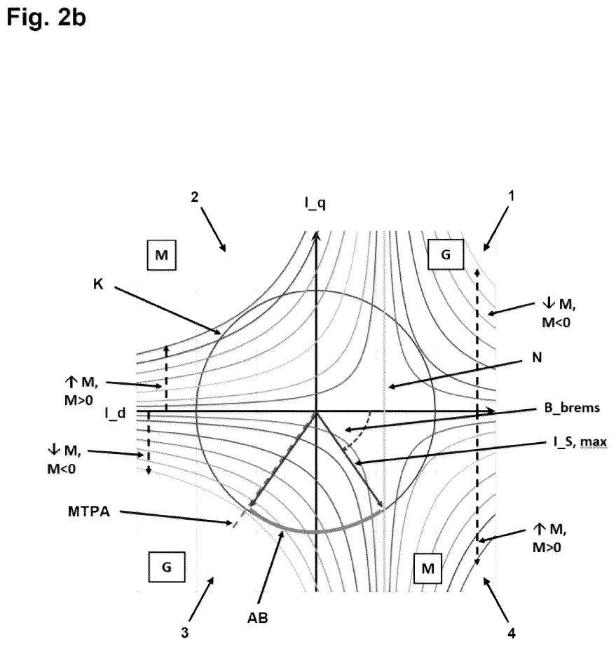

FIG. 1 shows the four quadrants 1, 2, 3 and 4 of a space vector representation. The first quadrant 1 is characterized by a negatively rising torque ⬆M and generator operation G. The second quadrant 2 is characterized by a positively rising torque ⬇M and motor operation M. The third quadrant 3 is characterized by a negatively rising torque ⬆M and motor operation M. The fourth quadrant 4 is characterized by a positively rising torque ⬇M and generator operation G. The rising or falling torques of the torque hyperbolae are symbolized by dashed arrows in FIGS. 1 and 2. The torque hyperbolae are preferably formed by operating points with the same torque. FIG. 1 shows a circle K, the circle K representing the current limit of an inverter of the power tool 10. The circle K, or the current limit of the inverter, has equal parts located in the four quadrants 1, 2, 3, 4 of the space vector representation, which is synonymous with a centre of the circle K coinciding with the intersection of the y and x axes of the space vector representation. The operating range AB of the stator current space vector I_S is shown in the third quadrant 3 of the space vector representation. In the space vector representation shown in FIG. 1, the operating range AB of the stator current space vector I_S coincides with the MTPA characteristic curve of the power tool 10. The motor 12 of the power tool 10 is thus advantageously operated at an efficiency-optimized operating point at which the electrical heat losses are minimal.

The 0 Nm characteristic curve N, which runs substantially parallel to the y-axis of the space vector representation, runs through the first quadrant 1 and the fourth quadrant 4. Moreover, a second 0 Nm characteristic curve N2, which runs on the x-axis, or coincides with the x-axis (therefore not shown), is obtained. The space vector representation depicted in FIG. 1 shows a power tool 10, or operation thereof, for which the braking power of the power tool 10 is reduced as a result of at least one correction factor k being determined and applied to a maximum motor current I_S, max of the power tool 10, so that a reduced setpoint value I_S, red for the motor current is obtained. This corresponds to efficient regenerative braking operation of the power tool 10 (see FIG. 9).

FIGS. 2a and 2b show a space vector representation of supremely lossy regenerative braking operation of a power tool 10. Contrary to FIG. 1, the braking methods shown in FIG. 2 involve a current space vector I_S, max being rotated in the space vector representation by applying a modified braking angle β_brems, so that a length of the current space vector I_S, max remains essentially unchanged and the braking power of the power tool 10 is reduced. The current space vector I_S, max is initially in the third quadrant 3 of the space vector representation, but ends up at the border between the second quadrant 2 and the third quadrant 3 as a result of the rotation in FIG. 2a. The current space vector I_S, max is initially in the third quadrant 3 of the space vector representation, but ends up in the fourth quadrant 4 as a result of the rotation in FIG. 2b. The braking angle β_brems is also shown in the fourth quadrant 4 of the space vector representation. The rotated current space vector I_S, max in the fourth quadrant 4 intersects the circular area K representing the current limit of the inverter of the electronics of the power tool 10, this intersection of the rotated current space vector I_S, max and the circular area K in the example depicted in FIGS. 2a and 2b coinciding with the intersection of the circular area K and the 0 Nm characteristic curve N. The operating range AB is therefore limited to operating points between the states “maximum braking torque” and “no braking torque, i.e. 0 Nm”.

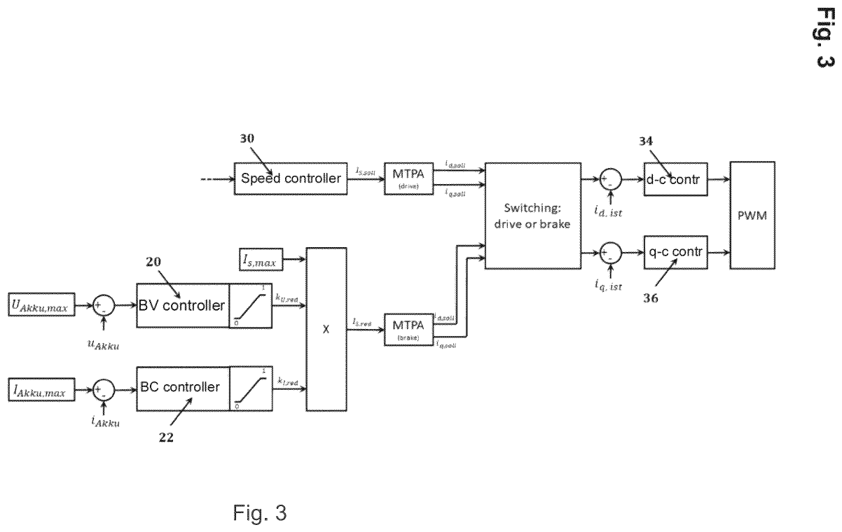

It should be noted that the block diagrams shown in FIGS. 3 to 6 show, by way of illustration, braking methods for a power tool 10 that involve the motor 12 being operated using field-oriented control. The method can of course also be carried out with a power tool 10 in which the motor 12 is controlled using block commutation. The motor 12 of the power tool 10 is a brushless motor that can preferably deliver a power of more than 1800 watts (W).

FIG. 3 shows a possible “recuperation” block diagram with efficient regenerative braking operation of a power tool 10 without a brake chopper 18. In the braking methods depicted in FIG. 3, the battery voltage controller 20 is configured to output a correction factor k_U, red for the voltage of the power supply device 14, while the battery current controller 22 is configured to output a correction factor k_I, red for the current of the power supply device 14. Moreover, there is provision for a speed controller 30 that controls the speed n of the power tool 10. Setpoint current values that can be relayed to the motor current controllers 34, 36 are obtained as output variables or manipulated variables of the braking method. The setpoint current values may preferably be setpoint current values for the d- and q-axes of the space vector representation. The motor current controllers 34, 36 are in particular a d-current controller 34 and a q-current controller 36, the motor current controllers 34, 36 relaying their control commands to the pulse width modulation PWM.

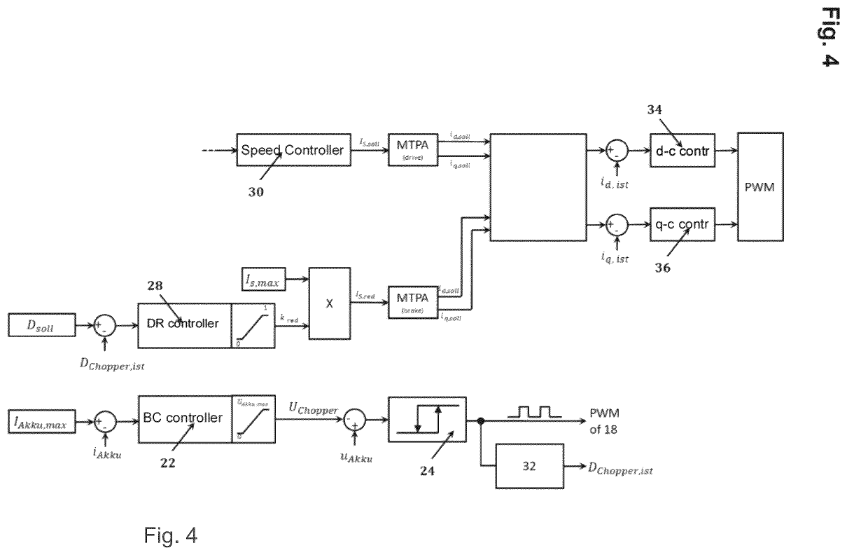

FIG. 4 shows a possible “recuperation” block diagram with efficient regenerative braking operation of a power tool 10 with a brake chopper 18. The block diagram shown in FIG. 4 depicts the battery current controller 22, the speed controller 30 and the motor current controllers 34, 36 that are already known from FIG. 3 and the block diagram shown therein. Moreover, FIG. 4 shows a duty ratio controller 28, which can also be referred to as “third controller” and is used to limit the duty ratio to a setpoint value D_soll of, for example, 95%. The output value of this third controller is a correction factor k_red that is between the values 0 and 1. This correction factor k_red can be multiplied by the current I_S, max to obtain the reduced setpoint motor stator current I_S, red.

Moreover, the block diagram shown in FIG. 4 shows a two-level controller 24 with hysteresis, which is referred to as “first controller”. This first controller 24 is preferably used to actuate the braking resistor 18 referred to as “brake chopper”. The first controller 24 may, for example, be in the form of a comparator with switching hysteresis and be configured to compare a DC link voltage with a reference voltage. The DC link voltage can preferably also be referred to as battery voltage u_Akku, while the reference voltage in FIG. 4 is referred to by the name “U_Chopper”. The first controller 24 outputs as output signal a PWM signal that outputs a high level if the battery voltage is greater than the reference voltage, i.e. u_Akku>u_Chopper. A duty ratio of the PWM signal can be formed, for example, by the low pass filter 32 shown in FIG. 4. Values or variables that vary over time are denoted by lower case letters in this specification, while constant values or variables, such as limit values or other specified values, are denoted by upper case letters.

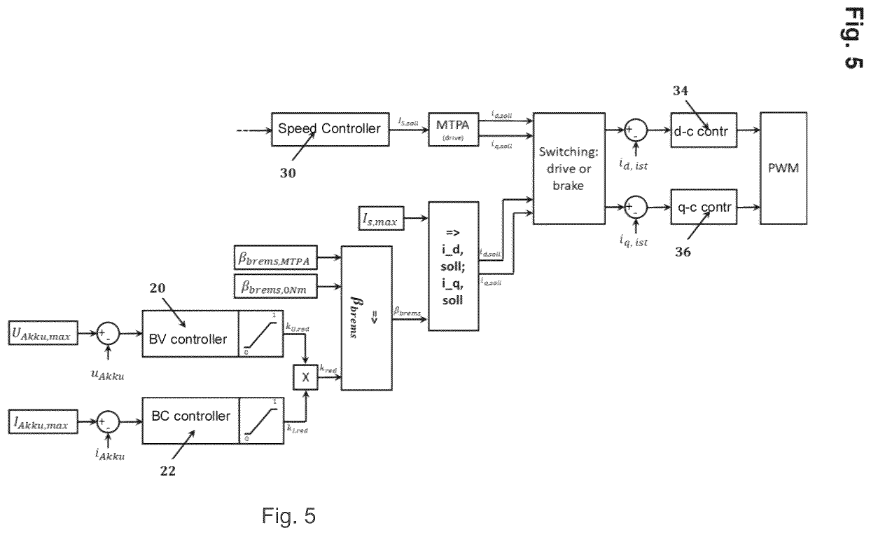

FIG. 5 shows a possible “recuperation” block diagram with supremely lossy regenerative braking operation of a power tool 10 without a brake chopper 18. Similarly to the block diagram of FIG. 3, the braking method described in FIG. 5 involves correction factors k_U, red and k_I, red being output, which can be combined to form a common correction factor k_red. The correction factor k_red used in FIG. 5 results preferably from a combination of the correction factors k_U, red and k_I, red for the voltage and the electrical current. The correction factor k_red in the example shown in FIG. 5, in which a brake chopper 18 is preferably not used, has no portion that is attributable to a duty ratio of the brake chopper 18.

In particular, the correction factor k_U, red can be determined by the battery voltage controller 20 and the correction factor k_I, red can be determined by the battery current controller 22. The correction factors k_U, red and k_I, red can be used to calculate the combined correction factor k_red, which can be used to calculate the stator current space vector angle or braking angle β_brems. This is accomplished by subtracting the angles β_brems, MTPA and β_brems, 0 Nm from one another and multiplying them by the combined correction factor k_red. The β_brems, 0 Nm can be added to the product again, and so the braking angle β_brems is obtained. The parameter β_brems, MTPA preferably signifies the angle on the MTPA characteristic curve, while the parameter β_brems, 0 Nm corresponds to the stator current space vector angle in the fourth quadrant 4 of the space vector representation or to the stator current space vector angle on the x-axis between the second quadrant 2 and the third quadrant 3, at which no torque is generated. This parameter β_brems, 0 Nm in the fourth quadrant 4 is preferably obtained from the intersection of the current limit circle K with the 0 Nm characteristic curve N. The braking angle β_brems and the current I_S, max can be used to calculate the d- and q-setpoint values that can be forwarded to the d-current controller 34 and the q-current controller 36.

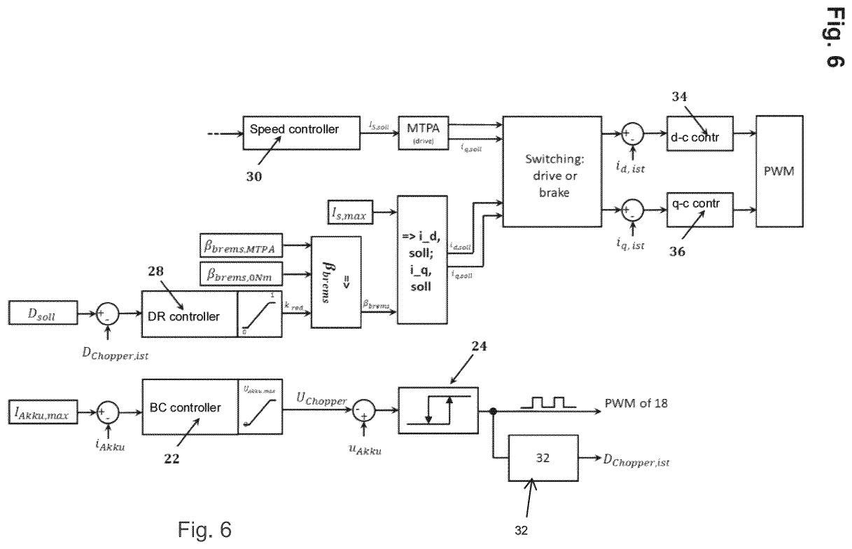

FIG. 6 shows a possible “recuperation” block diagram with supremely lossy regenerative braking operation of a power tool 10 with a brake chopper 18, the block diagram shown in FIG. 6 broadly showing a combination of elements of the block diagrams from FIGS. 4 and 5.

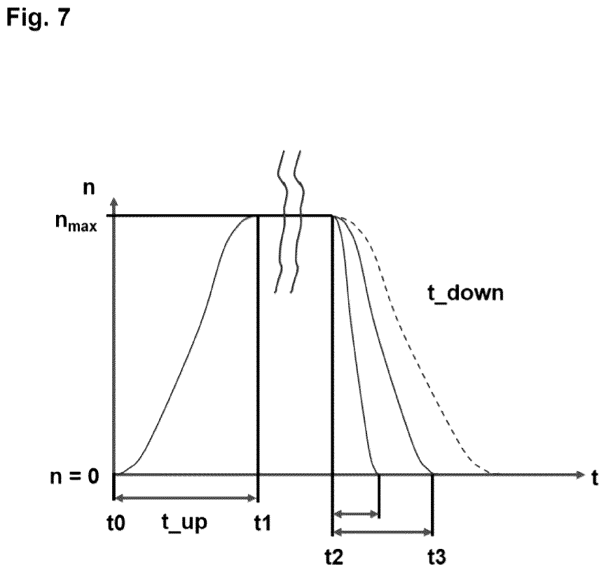

FIG. 7 shows a schematic plot of the speed n of the motor 12 of the power tool 10 against time t to illustrate the braking time t_down and the acceleration time t_up. It shows a possible response of the speed n with an interruption between times t1 and t2. In the period of time between times to and t1, the speed n of the power tool 10 rises in order to reach a maximum value n_max at time t1. This period of time between the limits t1 and t2 is referred to as acceleration time t_up in accordance with this specification. From the maximum speed value n_max, the power tool 10 can be brought to a standstill by way of a slowing operation. In the case of conventionally operating power tools, such a braking operation can take place as per the dashed line in FIG. 7 and, for example, can take longer than the acceleration time t_up. In this case, a ratio of braking time and acceleration time may be greater than 1, because the braking time t_down is greater than the acceleration time t_up. In the plot of speed n against time t shown in FIG. 7, the braking time t_down is limited by times t2 and t3.

By preference, the braking of the power tool 10 has a response as per the two solid lines in FIG. 7. Slowing down according to a normal slowing operation takes place as per the right-hand solid line, a braking time t_down being in a range between 2 and 4 seconds. In such a case, the ratio of braking time and acceleration time may be less than 1, i.e. the braking time t_down is less than the acceleration time t_up. After a kickback situation has been detected, the power tool 10, or its tool 16, can be slowed down in less than 1.5 seconds. A fast or kickback braking operation such as this is represented by the left-hand solid line in FIG. 7. In such a case, the ratio of braking time and acceleration time may be less than 0.7, preferably less than 0.5, i.e. the braking time t_down is significantly less than the acceleration time t_up. By way of example, the braking time t_down may be less than 70%, preferably less than 50%, of the acceleration time t_up.

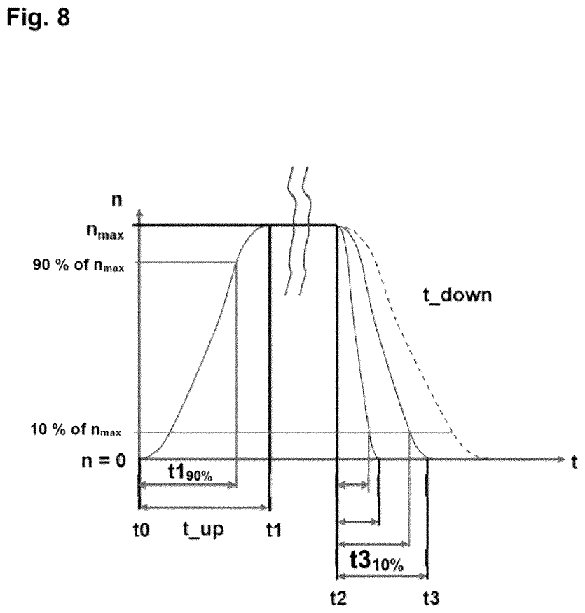

FIG. 8 also shows a schematic plot of the speed n of the motor 12 of the power tool 10 against time t to illustrate the braking time t_down and the acceleration time t_up. The inventors have recognized that at reduced speed the rotating cutting disk 16 now has only very little rotational energy and is therefore a low risk for the user of the power tool 10. It may be sufficient that the tool 16 of the power tool 10 is not brought to a complete standstill, but rather the braking operation ends before, for example when the tool 16 of the power tool 10 is rotating at a speed n of less than 70%, preferably less than 63%, 55%, 45%, 32% or 22%, of the original speed n_max of the tool 16. Of course, the tool 16 of the power tool 10 can also rotate at an even lower proportion of the original speed n_max before it is slowed down to a standstill, for example. The end of the braking time t_down is then determined accordingly by end times t3_70%, t3_63%, t3_55%, t3_45%, t3_32%, or t3_22%. Of course, all intermediate values between 70 and 0% are also possible, such as for example 67%, 57.5%, 43.33%, 2.56%, etc. It is preferred that the tool 16 of the power tool 10 is deprived of the greater share of its rotational energy, which is fed back to the power supply device 14 of the power tool 10. As a result of the large share of the rotational energy being taken away, the tool 16 of the power tool 10 can be slowed down so sharply that the rotating cutting disk 16 is no longer a danger to the user of the power tool 10. If the braking time t_down first ends not when the tool 16 of the power tool 10 is at a standstill, but rather when the tool 16 of the power tool 10 is only rotating at less than 70%, preferably less than 63%, 55%, 45%, 32%, 22%, of the original speed n_max of the tool 16, the period of time before the tool of the power tool is actually at a standstill is advantageously no longer important, because the braking time t_down, or the end t3 thereof, is defined by the attainment of the lower speed.

It is possible that the power tool 10 or its tool 16 is brought to a standstill with a reduced gradient having a different slope.

The plot of speed n against time t shown in FIG. 8 shows in particular constant straight lines for the values of 90% of the maximum speed n_max and 10% of the maximum speed n_max. The value of 90% of the maximum speed n_max forms a value pair together with the associated time value t1_90%, said value pair lying on the graph n (t). Analogously, the value of 10% of the maximum speed n_max forms a value pair together with the associated time value t3_10%, said value pair lying on the graph n (t).

FIG. 9 shows a schematic representation of a preferred configuration of the power tool 10. The power tool 10 has a motor 12, which is preferably in the form of a brushless motor. The power tool 10 can have a tool 16, which may, for example, be in the form of a disk-shaped cutting tool. The power tool 10 depicted in FIG. 9 is preferably a cut-off grinder that can be used to make cuts in a substrate, such as concrete. The tool 16 of the power tool 10 may be surrounded by a blade guard (without a reference sign) in order to protect the user of the power tool 10 from flying chips and sparks. The power tool 10 can be connected to at least one power supply device 14 in order to supply the power tool 10 with electrical energy. Of course, the power tool 10 can also have two or more power supply devices 14. In the context of the present invention, electrical energy can be fed back to the at least one power supply device 14, in particular when the power tool 10 is slowed down. Excess electrical energy that could damage the power supply device can be removed by the brake chopper and, if necessary, prevented by reducing the motor current. The power tool 10 can moreover have one or more handles as shown that the user of the power tool 10 can use to transport the power tool 10 or guide it during work.

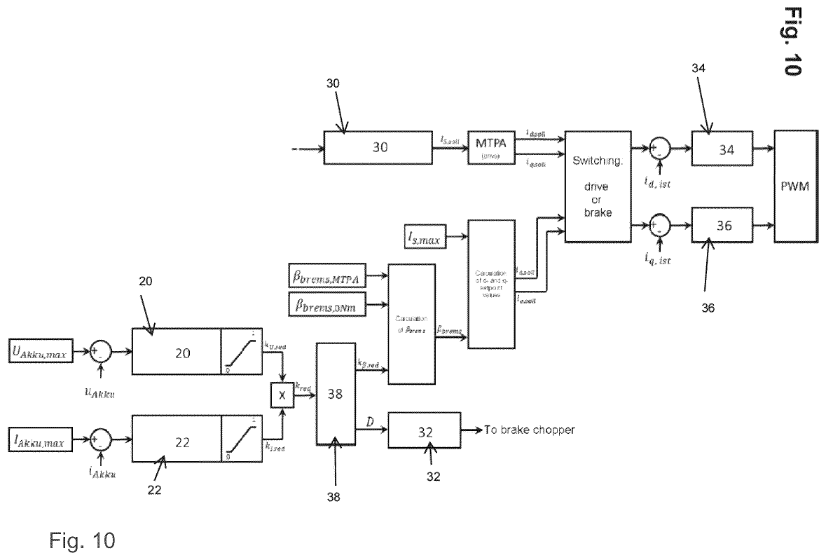

FIG. 10 shows an inventive block diagram of an inventive method for braking a power tool. In the braking method depicted in FIG. 10, the battery voltage controller 20 is configured to output a correction factor k_U, red for the voltage of the power supply device (14, FIG. 9), while the battery current controller 22 is configured to output a correction factor k_I, red for the current of the power supply device 14. Moreover, there is provision for a speed controller 30 that controls the speed n of the power tool 10. Setpoint current values that can be relayed to the motor current controllers 34, 36 are firstly obtained as output variables or manipulated variables of the braking method. The setpoint current values may preferably be setpoint current values for the d- and q-axes of the space vector representation. The motor current controllers 34, 36 are in particular a d-current controller 34 and a q-current controller 36, the motor current controllers 34, 36 relaying their control commands to the pulse width modulation PWM. Secondly, the braking method according to FIG. 10 provides a manipulated variable for the duty factor D of the brake chopper.

The inventive braking method shown in FIG. 10 differs from the braking method according to FIG. 4 in particular in that no additional controller is required for controlling the brake chopper. Rather, the braking method according to FIG. 10 involves control of the brake chopper being achieved exclusively by way of the current controller 20 and the voltage controller 22. For this purpose, a mapping algorithm 38 is proposed, in particular, which takes the first correction parameter k_U, red and the second correction parameter k_I, red (e.g. takes a product of the first and second correction parameters k_U, red; k_I, red) as a basis for firstly outputting a first manipulated variable k_β, red for (potentially) reducing the motor current via a rotation of the current vector. Secondly, the mapping algorithm 38 determines the duty factor D of the brake chopper as a second manipulated variable. In regard to rotation of the current space vector, reference should also be made to the explanations relating to FIG. 5.

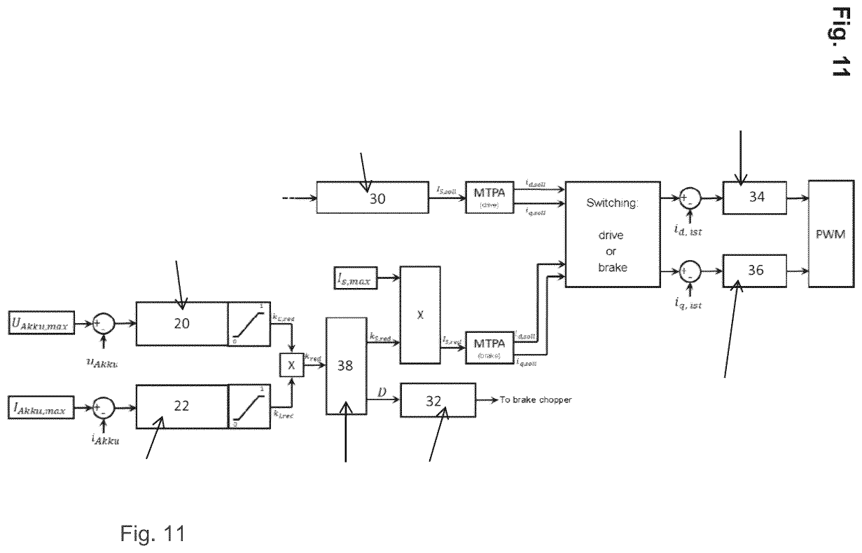

The braking method shown in the block diagram according to FIG. 11 differs from the braking method shown in FIG. 10 in particular in that the proposal is to shorten the current space vector I_S, max in order to reduce the motor current. In regard to shortening of the current space vector I_S, max, reference should also be made to the explanations relating to FIGS. 3 and 4.

FIG. 11 also shows a mapping algorithm 38 that takes the first correction parameter k_U, red and the second correction parameter k_I, red (e.g. takes the correction factor k_red, which is the product of the first and second correction parameters k_U, red; k_I, red) as a basis for firstly outputting a first manipulated variable k_S, red for (potentially) reducing the motor current via a shortening of the current vector. Secondly, the mapping algorithm 38 determines the duty factor D of the brake chopper as a second manipulated variable.

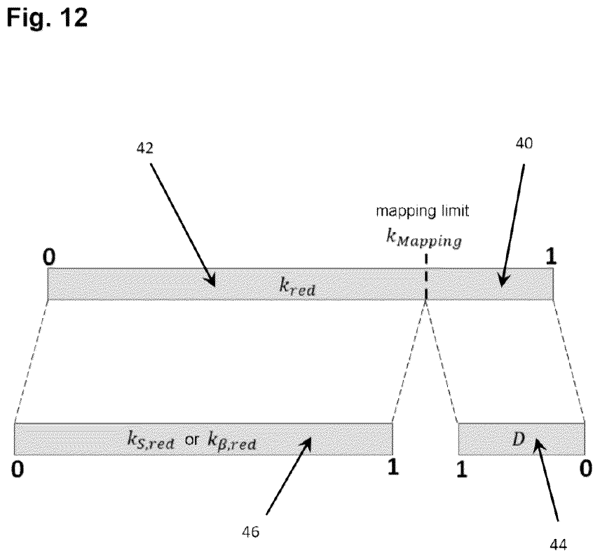

Each of the braking methods shown in FIGS. 10 and 11 involves a mapping algorithm being used that is designed to use the product of the two correction parameters, i.e. to take the correction factor k_red as a basis, for outputting firstly a manipulated variable for reducing the motor current and secondly the duty factor D of the brake chopper. An illustrative mapping algorithm is shown in FIG. 12.

According to the mapping algorithm of FIG. 12, the required reduction of the energy released by braking, to protect the power supply device, is easily divided between the brake chopper and a reduction in the motor power. Specifically, high correction factors (i.e. only small amounts of excess energy) merely result in the duty factor of the brake chopper being changed. The motor current is not yet reduced here, and so the power supply device can continue to be charged with maximum permissible feedback power in this range without having to reduce the motor braking power. If the correction factor k_red is too low (i.e. large amounts of excess energy are generated), then besides using the brake chopper (under full load) the motor current is also reduced. The transition between removal of the excess energy solely by the brake chopper (first range 40 in FIG. 12) and reduction of the motor current (i.e. reduction of the regenerative braking power) to limit the excess energy (second range 42 in FIG. 12) is referred to as the mapping limit k_Mapping.

In FIG. 12, the mapping limit is reached, by way of illustration, at k_red=0.75. A first range 40 of the correction factor k_red, above the mapping limit k_Mapping, is used to control the brake chopper. A second range 42 of the correction factor k_red, below the mapping limit k_Mapping, is used to control (reduce) the motor current. It should be mentioned at this point that the mapping limit k_Mapping shown is only an illustration and can generally assume any value of the correction factor k_red between 0 and 1. In the example of the mapping limit at k_red=0.75 shown here, excess energy that is released during braking is absorbed by the brake chopper if the correction factor k_red is in the first range 40, i.e. between 0.75 and 1. In this first range 40, the behaviour of the duty factor D of the brake chopper is directly proportional to that of the correction factor k_red. The brake chopper duty factor D is therefore in a duty factor range 44 between 0 and 1 when the correction factor k_red is in the first range 40. In other words, a correction factor k_red that is in the middle of the first range 40 (here k_red=0.875) corresponds to a duty factor of the brake chopper of 0.5. When a correction factor k_red is less than or equal to k_Mapping (here 0.75), the duty factor of the brake chopper is 1, i.e. the brake chopper operates at full braking power.

When the correction factor k_red is below the mapping limit k_Mapping (here below 0.75), the mapping algorithm 38 (depending on the embodiment) outputs either a current correction factor k_S, red or a brake angle correction factor k_B, red in order to reduce the motor current and thus the energy generated during braking. The discussion below will merely concern determination of the current correction factor k_S, red, the sequence being able to be transferred equivalently to the determination of the brake angle correction factor k_β, red.

As indicated in FIG. 12, the current correction factor k_S, red decreases proportionally with the correction factor k_red as soon as the correction factor k_red is below the mapping limit k_Mapping. In the example cited above, i.e. if the mapping limit has been set to 0.75, this means that the current correction factor k_S, red is in the current correction factor range 46 between 1 and 0 if the correction factor k_red is in the second range 42 between the mapping limit k_Mapping (e.g. 0.75) and 0. In other words, a correction factor k_red that is in the middle of the second range 42 (here k_red=0.375) means a current correction factor k_S, red of 0.5, i.e. the motor current is lowered by 50%. When a correction factor k_red is greater than or equal to k_Mapping (here 0.75), the current correction factor k_S, red=1, i.e. there is no lowering of the motor current, etc. Throughout the second range 42 of the correction factor k_red, the duty factor of the brake chopper=1, i.e. the brake chopper operates under full load.

The determination of the current correction factor k_S, red and the duty factor D of the brake chopper by way of the mapping algorithm 38 can be expressed using the following logic:

$$if ( {k}_{red} \leq {k}_{Mapping} )$$

$$\{$$

$${k}_{S , red} or {k}_{β , red} = \frac{{k}_{red}}{{k}_{Mapping}} ;$$

$$D = 1 ;$$

$$\}$$

$$else$$

$$\{$$

$$D = \frac{1}{( {k}_{Mapping} - 1 )} \cdot {k}_{red} - \frac{1}{( {k}_{Mapping} - 1 )} ;$$

$${k}_{S , red} or {k}_{β , red} = 1 ;$$

$$\}$$

As already indicated above, the mapping limit k_Mapping may be a constant (e.g. manufacturer-defined) value or dynamically alterable. It is particularly advantageous if the mapping limit k_Mapping is calculated dynamically, so that a load line without a bend is always approximated. A preferred value for the mapping limit k_Mapping can accordingly be calculated as follows:

$${k}_{Mapping , opt} = \frac{{P}_{mech}}{{P}_{mech} + {P}_{Chopper}}$$

where P_{mech}=mechanical braking power of the power tool, and P_{Chopper}=braking power of the chopper.

For an example of P_{mech}=3000 W and P_{Chopper}=1000 W, the mapping limit of k_Mapping=3000 W/(3000 W+1000 W)=¾=0.75 mentioned by way of illustration above is therefore obtained.

### LIST OF REFERENCE SIGNS

1 first quadrant of the space vector representation
2 second quadrant of the space vector representation
3 third quadrant of the space vector representation
4 fourth quadrant of the space vector representation
10 power tool
12 motor
14 power supply device
16 tool
18 brake chopper
20 voltage controller of the power supply device
22 current controller of the power supply device
24 first controller
26 second controller
28 third controller, in particular duty ratio controller
30 speed controller
32 low pass filter
34 d-current controller
36 q-current controller
38 mapping
40 first range
42 second range
44 duty factor range
46 range of reduced braking power
M motor operation
G generator operation
I_d torque
I_q torque
⬆M positively rising torque
⬇M negatively rising torque
K circular area as the current limit of the inverter
AB operating range of the stator current space vector
N 0 Nm characteristic curve
MTPA MTPA (maximum torque per ampere)
   characteristic curve
β_brems braking angle
PWM pulse width modulation
n speed
t time

What is claimed is:

1. A method for braking a power tool, the power tool being a battery-operated or mains-operated power tool and having a brake chopper, at least part of electrical energy released when the power tool is braked being fed back to a power supply device or a DC link of the power tool, the method comprising the following steps:
a) regeneratively braking a motor-driven drive of the power tool;
b) feeding back the electrical energy released when the power tool is braked to the power supply device or the DC link of the power tool;
c) determining whether the electrical energy released when the power tool is braked exceeds at least one limit value of the power supply device or of the voltage of the DC link; and
d) absorbing a share of the electrical energy by way of the brake chopper if the electrical energy released during braking exceeds the at least one limit value of the power supply device or of the voltage of the DC link.

2. The method as recited in claim 1 wherein a correction factor (k_{red}) is determined on the basis of a difference between the electrical energy released during braking and the limit value of the power supply device or of the voltage of the DC link, and wherein a duty factor D of the brake chopper is determined on the basis of the correction factor (k_{red}).

3. The method as recited in claim 2 wherein the correction factor (k_{red}) is in a range from 0 to 1.

4. The method as recited in claim 2 wherein the correction factor (k_{red}) is made up of a first correction parameter (k_{U_red}) and a second correction parameter (K_{I_red}).

5. The method as recited in claim 4 wherein the correction factor (k_{red}) is a product of the first correction parameter (k_{U_red}) and the second correction parameter (k_{I_red}).

6. The method as recited in claim 4 wherein the first correction parameter (k_{U_red}) is determined by a voltage controller of the power supply device, and wherein the second correction parameter (K_{I_red}) is determined by a current controller of the power supply device.

7. The method as recited in claim 2 wherein the duty factor D of the brake chopper is determined on the basis of a ratio of the correction factor (k_{red}) to a mapping limit (k_{Mapping}), the mapping limit (k_{Mapping}) corresponding to a limit value of the correction factor (k_{red}) from which the braking power of the power tool is reduced.

8. The method as recited in claim 7 wherein the duty factor D of the brake chopper has the value 1 if the correction factor (k_{red}) is less than or equal to the mapping limit (k_{Mapping}).

9. The method as recited in claim 7 wherein the duty factor D of the brake chopper is determined using the following formula while the correction factor (k_{red}) is above the mapping limit (k_{Mapping}):
$$D = {k}_{red} / ( {k}_{Mapping} - 1 ) - 1 / ( {k}_{Mapping} - 1 )$$

10. The method as recited in claim 7 wherein the mapping limit (k_{Mapping}) has a value between 0 and 1.

11. The method as recited in claim 7 wherein the mapping limit (k_{Mapping}) is a constant, predetermined value.

12. The method as recited in claim 7 wherein the mapping limit (k_{Mapping}) is determined dynamically on the basis of a mechanical braking power (P_{mech}) of the power tool and a chopper braking power (P_{Chopper}).

13. The method as recited in claim 12 wherein the mapping limit is determined using the following formula:
$${k}_{Mapping} = {P}_{mech} / ( {P}_{mech} + {P}_{Chopper} )$$

14. The method as recited in claim 7 wherein the braking power of the power tool is reduced by way of the following method step:
e) rotating a current space vector I_{S,max} in the space vector representation by applying a modified brake angle β_{brems}, with the result that a length of the current space vector I_{s, max} remains essentially unchanged, or
f) applying a current correction factor k_{S,red} to a maximum motor current I_{S, max}, as a result of which a reduced setpoint value I_{S,red} for the motor current is obtained.

15. The method as recited in claim 14 wherein the current correction factor K_{S,red} is determined on the basis of a ratio of the correction factor k_{red} to the mapping limit (k_{Mapping}).

16. The method as recited in claim 7 wherein the current correction factor k_{S,red} is determined using the following formula while the correction factor k_{red} is below the mapping limit (k_{Mapping}):
$${k}_{S , red} = {k}_{red} / {k}_{Mapping}$$

17. A power tool comprising a motor and a brake chopper for carrying out the method as recited in claim 1, the motor being a brushless motor.
